(19) United States
(12) Patent Application Publication
(10) Pub. No.: US 2005/0242948 A1
(43) Pub. Date: Nov. 3, 2005

(54) Alarm system

(76) Inventor: Jeff Tarr, New York, NY (US)

Correspondence Address: FISH & RICHARDSON P.C., P.O. BOX 1022, MINNEAPOLIS, MN, 55440-1022, US

(21) Appl. No.: 10/836,839

(22) Filed: Apr. 30, 2004

(51) Int. Cl. G08B 1/08

(52) U.S. Cl. 340/539.22; 340/870.01

(57) ABSTRACT

Methods and techniques for an alarm system include one or more sensors and a transceiver coupled to the sensors and wirelessly coupled to a remote location. A speaker coupled to the transceiver can enable two-way communication with the remote location. In some implementations, the transceiver is adapted to communicate output data of the sensors to the remote location wirelessly. The alarm system can include a recorder coupled to the sensors and adapted to store information output from the sensors.

### BACKGROUND

This disclosure relates to wireless alarm systems.

Buildings, including those for residential and/or business occupancy, can have multiple floors and are often equipped with alarm systems that respond, for example, to the detection of fire and smoke. These alarm systems often are installed as the building is being built so that the wiring of the alarm systems may be concealed from view in the walls.

In some older buildings, wiring for alarm systems may not have been installed when the building was constructed and may not have been installed since that time. Adding wiring after a building is completed can require running conduits throughout the building and may involve cutting through walls and floors.

Some buildings may have alarm systems with limited features. For example, a building may have a fire alarm on each floor for a person to activate. Upon activation, a bell or other alarm indication may alert a person in the building's management office or other central location. The alarm indication does not always include information about where in the building the emergency has occurred.

An evacuation alarm system may include voiced information. For example, an instruction to evacuate a building may be given over a loudspeaker. Loudspeakers can be placed on each floor in a building and controlled from a central control device. These systems may play pre-recorded messages or play a message spoken into a microphone from the central control device. These systems may have dedicated wires from the central control device to each loudspeaker in the building.

Fire and other alarm systems can have a various types of sensors including temperature, smoke and motion sensors placed throughout the building. These sensors may have dedicated wiring from the sensors to the central control device. A control system for monitoring the alarm system can be located in a remote location or a building management office.

### BRIEF SUMMARY OF THE DISCLOSURE

The present application describes systems and techniques relating to an alarm system that includes one or more sensors. A transceiver is coupled to the sensors and wirelessly coupled to a remote location. A speaker coupled to the transceiver can enable two-way communication with the remote location. In some implementations, the transceiver is adapted to communicate output data of the sensors to the remote location wirelessly. The alarm system can include a recorder coupled to the sensors and adapted to store information output from the sensors.

In some embodiments, a router is coupled to a server and a switch to establish two-way communication between an alarm base station and the server. The alarm base station can include sensors such as a smoke detector, fire detector, heat detector, noise level detector, video camera, motion detector, carbon monoxide detector and carbon dioxide detector.

In another aspect, the techniques include a method of providing alarm system information by detecting an alarm condition from one or more sensors and automatically transmitting the alarm condition to a remote location. The technique includes enabling two-way wireless communication through a speaker between the remote location and the alarm system, so that a speaker associated with the alarm system enables the two-way communication, in part.

In another aspect, the techniques disclose a method of providing an alarm system by
placing one or more alarm base stations in one or more locations and providing wireless communication between the alarm base stations and a remote location. The technique includes monitoring the alarm base stations for an alarm condition of one or more of the alarm base stations and communicating wirelessly between the remote location and the alarm base station in an alarm condition.

The method of claim 16 wherein a power source provides power for at least one of the transceiver and the sensors.

The systems and techniques described here may provide one or more of the following advantages. The techniques may enable the installation of an alarm system at an existing site without running dedicated wiring. Installation of the alarm system without running dedicated wiring can result in ease of installation and lower cost over dedicated wiring systems. In some implementations, maintenance checks may be done while the system is still operational. The maintenance checks may be accomplished automatically or manually and at a periodic or ad-hoc time interval. Self-contained alarm base stations can be customized to provide different levels of security for various locations in a building. The system can maintain records of sensor output data to determine, for example, the efficiency of the heating, ventilation and air conditioning.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is an illustration of an alarm system.

FIG. 2 is a flow diagram for employing an alarm system.

FIG. 3 depicts an implementation of the topology of a illustrative alarm system.

FIG. 4 is a flow diagram of a process for responding to an alarm condition in an alarm system.

Like reference symbols in the various drawings indicate like elements.

### DETAILED DESCRIPTION

This disclosure relates to wireless alarm systems having two-way voice communication between an alarm base station and an alarm monitoring location. The alarm system may be particularly well suited for existing residential buildings in need of an alarm system.

An alarm base station can be self-contained and may be placed at desired locations throughout a building. The alarm base station can communicate the alarm status of sensors within the alarm base station to a central monitoring location wirelessly. The alarm system also provides for two-way wireless voice communication between the remote location and the alarm base station.

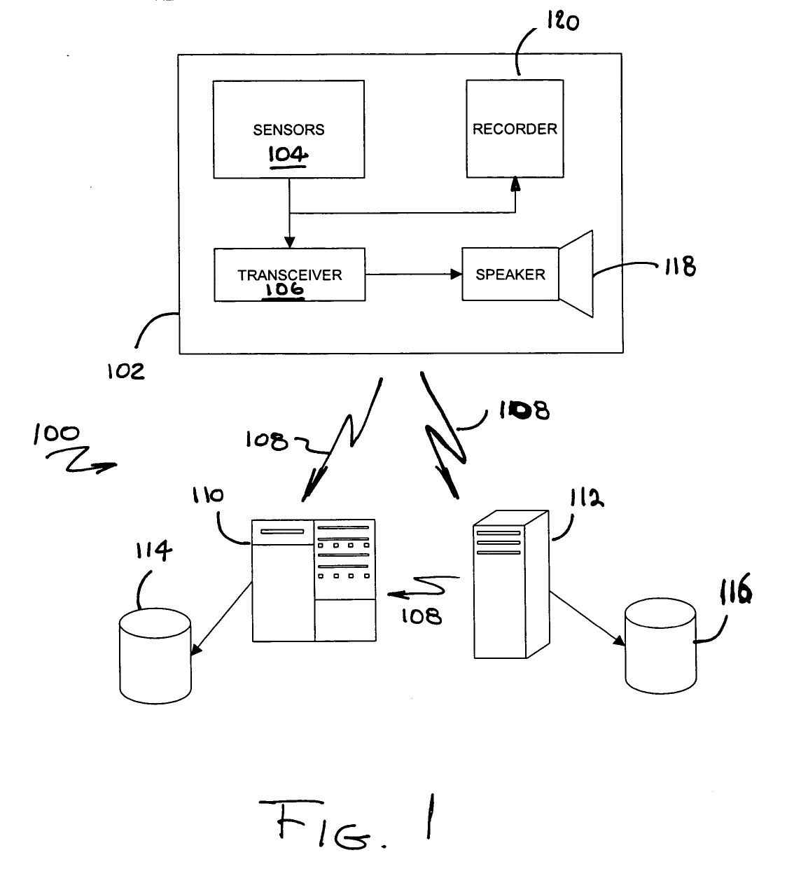

FIG. 1 illustrates an implementation of a wireless alarm system 100. An alarm base station 102 can include sensors 104 coupled to a transceiver 106. The transceiver can be in wireless communication with a remote location such as a central office server 110 or a building management office computer 112. The central server 110 or the building management office computer 112 may have memory 114, 116 respectively, to store data received from the alarm base stations. The alarm base stations 102 may include a speaker 118 coupled to the transceiver 106. The speaker provides amplification and two-way communication from a remote location to the alarm base station. A recorder 120 can be included in the base station to record readings of the sensors 104. The readings may be recorded, for example, at specific time intervals or during alarm conditions. In some implementations, a panic button (not shown) may be included and coupled to the transceiver.

Sensors 104 may determine when pre-determined conditions are detected at an alarm base station 102. The sensors can include, for example, a smoke detector, fire detector, heat detector, noise level detector, video camera, motion detector, carbon monoxide detector and carbon dioxide detector. An alarm threshold may be set for each respective sensor. An alarm condition exists when an alarm threshold of at least one of the sensors is exceeded. The sensor data may be provided to the transceiver 106. The transceiver can communicate the alarm condition wirelessly to a remote location such as the central server 110 or the building management office computer 112. Personnel at the remote location the remote location may respond to the alarm condition. Alternatively, the server 110 or office computer 112 may respond automatically with pre-recorded data. The remote location's response can be communicated wirelessly with the transceiver 106. Audible communications data received by the transceiver from the remote location may be provided to the speaker 118 to alert people in the area surrounding the alarm base station to an alarm condition. The speaker 118 also may be used as a microphone to receive audible communications from a person near the alarm base station and to provide that communication to the transceiver for transmission to the remote location. Thus, two-way communication between the remote location and the alarm base station may be implemented. Sensor output data may be recorded in the recorder 120 associated with the alarm base station. The recorder also may record any or all of the data and communications sent or received by the transceiver. In some implementations, a panic button may be activated to override the sensors and provide an alarm condition signal to the transceiver for transmission to the remote location. The panic button also may be used to initiate two-way communication with the remote location.

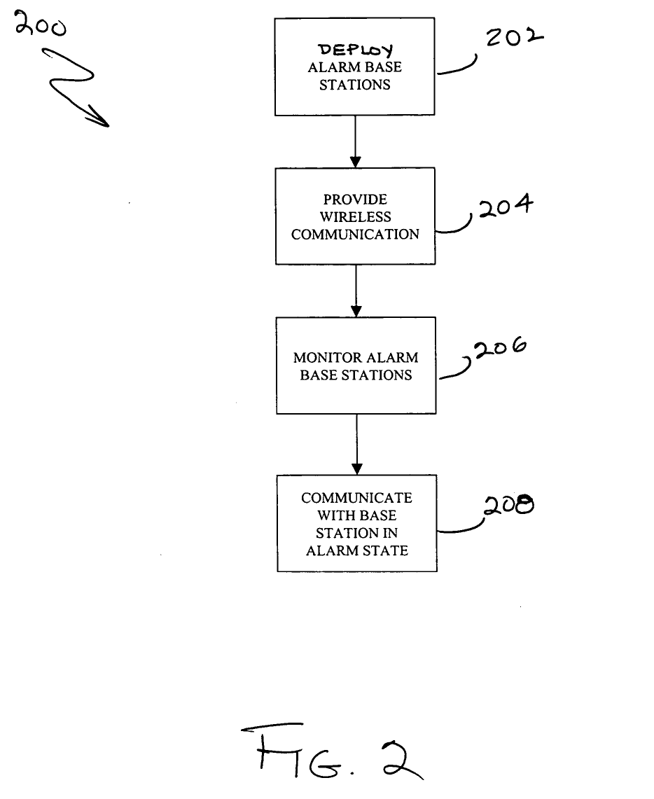

FIG. 2 is flow diagram 200 for an implementation of an alarm system installation. An alarm base unit may be disposed 202 in desired locations such as on every floor of a building. The alarm abase station can include sensors to detect temperature, smoke, video, and noise as well as a panic button and an amplified speaker. Data that these units record can be transmitted wirelessly 204 in real time to a remote location such as the building's management office and/or a remote management company. The system can be configured to have threshold levels assigned for the output of each sensor. Examples of the threshold levels include, the minimum and maximum temperatures for a heat detector, the amount of smoke for a smoke detector, the decibel level of sound for a noise detector and the magnitude of motion for a motion detector. Output levels from the sensors can be monitored 206 at the remote location. An alarm condition signal and associated sensor data can be communicated 208 to the remote location when the threshold level of a sensor is exceeded. The response to a specific alarm condition may be customized and can include alerting the building management or automatically sounding an alarm and summoning emergency services.

The communication may be two-way such that audible communications are received at a remote location from the alarm base station through the speaker and communications from the remote location are heard from the speaker at the alarm base station. A pre-recorded message or a real-time message spoken into a microphone can be played on any subset or all of the alarm base units throughout the building from any of the servers that maintain the building's alarm system, which can be on-site or off-site. People in the vicinity of the alarm base station can use the alarm base station speaker to communicate with the building management or other responsible party. For example, if a person needs evacuation assistance, they can push a button on the unit and speak to the building management or remote management company.

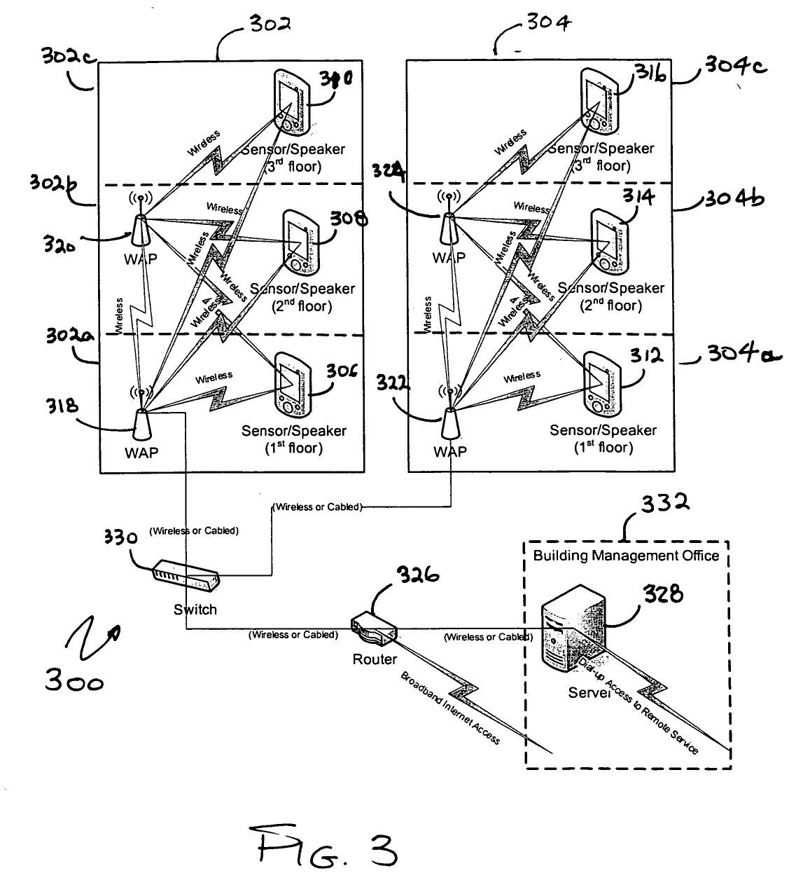

FIG. 3 illustrates an implementation of an alarm system 300 topology for a building complex having two buildings 302, 304. Building 302 has three floors 302a, 302b, 302c, and building 304 has three floors 304a, 304b, 304c. Alarm base stations 306-316 may be disposed throughout the buildings. The system topology can be a combination of wireless access points 318-324, alarm base stations 306-316, at least one server 328, a router 326 and network switches 330 as needed based on the size of the buildings. The server 328 may be located, for example, in a building's 302, 304 management office or other central alarm monitoring location 332. The alarm base stations may receive power (not shown) from any convenient source including batteries or the building's alternating current (AC) supply.

In the implementation illustrated, the alarm base stations in each building are in wireless communication with the wireless access points within the same building. Wireless communications may use a Wireless Application Protocol (WAP). At least one of the wireless access points 318, 322, for example, in each building is coupled, either by wire or wirelessly to the switch 330. The switch 330, in turn, is coupled either by wire or wirelessly to the router 326 for transmission by wire or wirelessly to the server 328. Communications from the server 328 to one or more alarm base systems are coupled through the router 326 to the switch 330 and then to the particular alarm base station. The server 328 also may be coupled to a remote monitoring service (not shown).

The system 300 can operate over a wireless network using the Transmission Control Protocol over Internet Protocol (TCP/IP) network protocol over both a wireless network layer such as IEEE Standard 802.11b or other similar wireless protocols and a traditional 10baseT wired network.

In an implementation, the router 326 may be installed either in the building's management office, security office, or basement depending on the specific building. Once installed, the router can be provided with a broadband Internet connection such as a Digital Subscriber Line (DSL) modem or cable modem. The router can be configured to create a secure Virtual Private Network (VPN) to the remote management company 332 such that all inbound Internet traffic comes from the remote management company and all outbound Internet traffic goes to the remote management company. This security procedure can aid in avoiding a risk of unauthorized access of the system over the Internet. The router may be enclosed in a custom made fire resistant and tamper proof enclosure.

The server 328 can be installed in the management, security or other building office. The server can be a computer that has been designed as a server. That is, the computer may have built in redundancy on the hard drives, power supplies, network cards and other components. The server 328 also may have a modem to communicate with a remote management company (not shown) in the event that the Internet connection is unavailable. The server can act as the Dynamic Host Configuration Protocol (DHCP) server for the network. Additional backup servers can be located elsewhere in the building. The primary server can be configured to replicate all of its data to backup servers automatically.

In some implementations, servers in the building can be connected to the router for access to both the wireless network and the Internet. The remote management company supporting the system also can access the system 300 and server 328 remotely with either dial up or Internet connectivity. This redundancy can provide additional reliability in managing and using the system because multiple people in a building can administer the system and, if one server becomes unavailable, a backup server can be employed.

The wireless access points 318-324 can be disposed in stairwells, conduits, ducts or other locations as needed throughout the building. The wireless access points can be outfitted with high-powered antennae to accommodate the size of the building. Multiple wireless access points can be installed throughout the area as needed for better range, coverage and redundancy of the wireless network. These devices also may be configured in bridge mode with each other to create a redundant network to aid in continuity of service of the system in the event of the failure of one or more components. The wireless access points can be enclosed in a custom-made fire resistant and tamper proof enclosure. Some of the wireless access points can be connected directly to the router or to a network switch, which in turn is connected to the router, depending on the wireless signal strength and size of the building.

The alarm base station units 306-316 may be installed such that there is at least one unit per floor and in rooms and areas in the building that are to be monitored. These units require electrical power, which may be by battery or from the building's AC power system. These units can be composed of a miniature PC computer or a handheld Personal Digital Assistant (PDA) style device and employ all or some of the following sensors: a thermometer, a smoke sensor, a video camera (often referred to as a webcam), a microphone, a motion detector, an amplified loud speaker, a panic button, a light that can display different colors to represent the unit's status and activity, and a radio frequency identification tag sensor (RFID sensor). An external antenna can be added as needed if the wireless network signal is weak. The alarm base system may be enclosed in a custom made fire resistant and tamper proof enclosure.

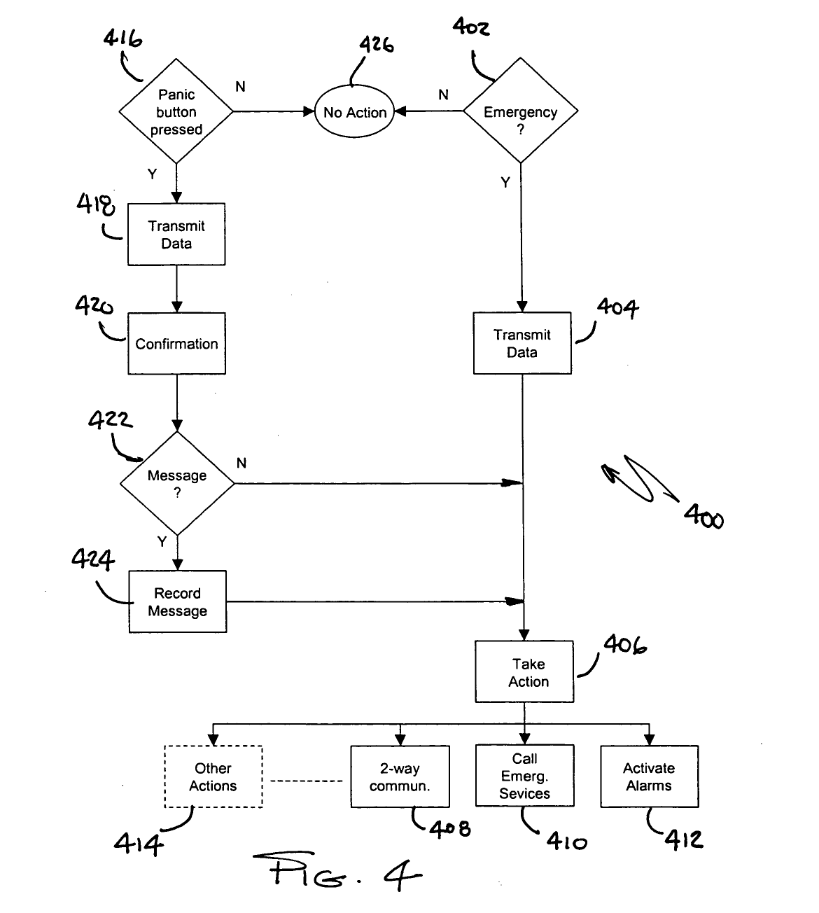

FIG. 4 is a flowchart 400 illustrating the operation of an alarm system that includes a panic button. The sensors are monitored 402 to determine if an emergency condition exists. If not, no action is taken 426. If one or more of the sensors detects an emergency because an output of the sensor exceeds a threshold value, then the sensor data are transmitted 404 to the server and to the remote management company. Action can be taken 406 either manually or automatically based on the type of emergency detected by the sensors. For example, in the case of a fire emergency the alarm system may activate 412 the alarms in appropriate areas of the building and emergency services may be called 410. In the case of a noise sensor alarm, the monitoring staff may enter 408 into a 2-way communication with a person at the alarm base station.

The alarm base station also can serve as a panic button. A person may press 416 the panic button. Upon activation of the panic button, the device can transmit 418 a message to the building management and remote management company containing some or all of the sensor data output including, in some implementations, a live video image. The alarm base system may be configured to play an audible confirmation message 420 simultaneously provide a status light on the unit or other indication to acknowledge that the panic button was activated. The building management or remote management company may manually or automatically prompt 422 the person at the alarm base station for a message, for example, by asking for a statement the problem. The person's spoken words can be recorded 424 by the recorder and transmitted to the server and remote management company. Based upon the type of emergency reported, a building manager or remote management employee can then take any of the actions 406 described above and/or engage in a two-way communication 408 with the person at the alarm base station. Depending on the desire of the building management, the remote management company can automatically contact emergency services such as the police and/or fire departments.

The equipment can be configured in a non-routable TCP/IP address scheme, such as the Internet specification document RFC 1918, 192.168.0.0 (Class B) address space, for added security. To ease management of the system, the server in the network can include a DHCP server that distributes IP addresses based on the Media Access Control (MAC) address of the requesting device. When a device is added to the network, the primary server must be programmed to accept that device's MAC address. This may provide an additional layer of security to prevent rogue devices from joining the network. The wireless communications also can be encrypted using a standard industry protocol such as Wireless Equivalent Privacy (WEP). A service set identifier (SSID) broadcasting can be disabled from the wireless access points to help make the network less visible to many computer users on the Internet. Additionally, the WEP keys can be changed automatically on a regular basis for additional security.

The alarm base station units 318-324 can communicate with the server 328 in the system by sending encrypted data using the Hyper Text Transfer Protocol Secure (HTTPS) protocol. The HTTPS protocol may be used by Internet websites for secure transactions such as purchases using a credit card number. The HTTPS base alarm systems can encrypt the data sent to the server 328 for added security before the server also using the HTTPS protocol transmits the data to a remote location. In an implementation, the base alarm stations can be configured to communicate with the server 328 after a a specified time period, such as sixty seconds, and to transmit sensor output data or other features of the alarm base station to the server. Thus, the server can report readings of the sensors, such as temperatures throughout the building, time of last detected motion or the noise level in decibels of each area. If an alarm base station fails to communicate data within the expected interval of time, the server may attempt to communicate with the device to determine the reason for the delay. If the communication attempt is unsuccessful, the server can be configured to alert the building management and the remote managing company of a failed unit. This implementation can provide for real-time maintenance (health) checks of the system.

The servers also may perform health checks on the Internet and dialup modem connections. After a predetermined time interval has elapsed, the server can confirm that the remote management company is accessible over the communications network. Should the remote management company be inaccessible, the server can be configured to notify the building management and, by alternative means such as a telephone, the remote management company. The remote management company's system also can be configured to alert the remote management company if a server does not respond to a health check.

The health checks may be useful in residential buildings that do not have “off-hours” in which the systems can be tested. If the system is not tested, it is possible that a fault exists that would prevent a alarm base station from functioning properly during an emergency. Similarly, a sensor in a fire and alarm system may fail to report a threshold that is exceeded when such a condition exists.

The server 328 also may be configured to replicate or back-up data received from the alarm base station units. The data can be backed-up to one or more backup servers. In the event that the server fails, one of the backup servers can be configured to replace the functions of the failed server. The alarm base stations can be switched automatically to communicate with the new server. When the failed server is repaired, the system can be configured to automatically switch back to the original server, or the switch can be done manually.

The alarm base station units 306-316 also can also be used in a standalone capacity for individuals who wish to monitor their homes or business. In this implementation, the alarm base station may be installed and integrated into the individual's existing wireless network. The alarm base station unit can have a built-in web server that enables the individual to access the sensor readings. The alarm base station also can be programmed to connect to a remote management system for emergency monitoring services.

Other embodiments are within the scope of the following claims.

1. An alarm system comprising:
one or more sensors;
a transceiver coupled to the sensors and wirelessly coupled to a remote location; and
a speaker coupled to the transceiver to enable two-way communication with the remote location.

2. The alarm system of claim 1 wherein the transceiver s adapted to communicate output data of the one or more sensors to the remote location wirelessly.

3. The alarm system of claim 1 comprising a recorder coupled to the sensors adapted to store information output from one or more of the sensors.

4. The alarm system of claim 3 wherein recorder is configured to record data received wirelessly from the remote location.

5. The alarm system of claim 1 wherein the communication comprises at least one of voice or data.

6. The alarm system of claim 1 comprising
a switch coupled to the transceiver;
a server; and
a router coupled to the switch and the server
wherein two-way communication is established from the alarm base station and the server.

7. The alarm system of claim 1 wherein the sensors are at least one of a smoke detector, fire detector, heat detector, noise level detector, video camera, motion detector, carbon monoxide detector and carbon dioxide detector.

8. The alarm system of claim 1 comprising a power source coupled to at least one of the transceiver and the sensors.

9. The alarm system of claim 8 wherein the power source is a battery.

10. A method of providing alarm system information, the method comprising:
detecting an alarm condition from one or more sensors;
automatically transmitting the alarm condition to a remote location; and
enabling two-way wireless communication through a speaker between the remote location and the alarm system,
wherein the two-way communication is enabled, in part, by a speaker associated with the alarm system.

11. The method of claim 10 wherein the sensors are at least one of a smoke detector, fire detector, heat detector, noise level detector, video camera, motion detector, carbon monoxide detector and carbon dioxide detector.

12. The method of claim 10 wherein a power source provides power for at least one of the transceiver and the sensors.

13. The alarm system of claim 10 comprising recording output data from one or more of the sensors.

14. A method of providing an alarm system, comprising:
placing one or more alarm base stations in one or more locations;
providing wireless communication between the alarm base stations and a remote location;
monitoring the alarm base stations for an alarm condition of one or more of the alarm base stations; and
communicating wirelessly between the remote location and the alarm base station in an alarm condition.

15. The method of claim 15 wherein the alarm base stations comprises one or more sensors, a transceiver coupled to the sensors, a speaker coupled to the transceiver to enable two-way communication with a remote location; and a power source to provide power for the transceiver and the sensors.

16. The method of claim 16 wherein a power source provides power for at least one of the transceiver and the sensors.

17. The method of claim 16 wherein the sensors are at least one of a smoke detector, fire detector, heat detector, noise level detector, video camera, motion detector, carbon monoxide detector and carbon dioxide detector.

18. The method of claim 15 comprising recording output data from one or more of the sensors.
